(19) United States
(12) Patent Application Publication
(10) Pub. No.: US 2023/0362870 A1
(43) Pub. Date: Nov. 9, 2023

(54) SATELLITE SYSTEM REAL TIME KINEMATIC POSITIONING IN WIRELESS COMMUNICATION NETWORK

(71) Applicant: Telefonaktiebolaget LM Ericsson (publ), Stockholm (SE)

(72) Inventors: Kai WANG, Milton (CA); Åke BUSIN, Sollentuna (SE); Ritesh SHREEVASTAV, Upplands Väsby (SE); Fredrik GUNNARSSON, Linköping (SE)

(21) Appl. No.: 18/245,194

(22) PCT Filed: Oct. 14, 2021
(86) PCT No.: PCT/IB2021/059473

§ 371 Date: Mar. 14, 2023

Related U.S. Application Data
(60) Provisional application No. 63/092,629, filed on Oct. 16, 2020.
(60) Provisional application No. 63/093,418, filed on Oct. 19, 2020.

(51) Int. Cl. H04W 64/00

(52) U.S. Cl. CPC H04W 64/00

(57) ABSTRACT

A method, network node and wireless device (WD) are disclosed for enhanced A-GNSS RTK positioning in 5G network by transferring neighbor cell information. According to one aspect, a method in a location server include receiving a request from the WD for positioning assistance data, the request identifying each of a plurality of cells and transmitting positioning assistance data to the WD. The method also includes determining whether positioning assistance data for a first cell of the identified cells is stored in the memory. When the positioning assistance data for the first cell is stored in the memory, then the positioning assistance data for the first cell is transmitted to the WD. When the positioning assistance data for the first cell is not stored in the memory, then whether positioning assistance data for a tracking area code associated with the WD location is stored in memory is determined.

### TECHNICAL FIELD

The present disclosure relates to wireless communications, and in particular, to enhanced Assisted Global Navigation Satellite System (A-GNSS) real-time kinematic (RTK) positioning in 3^{rd} Generation Partnership Project (3GPP) Fifth Generation (5G, also called New Radio or NR) networks.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

Wireless communication systems according to the 3GPP may include the one or more of following channels:
A physical downlink control channel, PDCCH;
A physical uplink control channel, PUCCH;
A physical downlink shared channel, PDSCH;
A physical uplink shared channel, PUSCH;
A physical broadcast channel, PBCH; and
A physical random access channel, PRACH.

Wireless device positioning is recognized as an important feature for 3GPP 4G and 5G networks due to the potential for massive commercial applications. For example, intelligent transportation, entertainment, industry automation, robotics, remote operation, healthcare, smart parking are all used cases for WD positioning. Also, WD positioning is relevant to United States (US) Federal Communications Commission (FCC) E911 requirements.

Positioning in LTE is currently supported by the architecture shown in FIG. 1, in which direct interactions between a WD and a location server (E-SMLC) is via the LTE Positioning Protocol (LPP). Moreover, there are also interactions between the location server and the eNodeB via the LPPa protocol, to some extent supported by interactions between the eNodeB and the WD via the Radio Resource Control (RRC) protocol. These interactions may be specified by various 3GPP Technical Specifications (TS).

The following positioning techniques are considered in LTE:
Enhanced Cell identification (ID). Essentially, the cell ID information is used to associate the WD to the serving area of a serving cell, and then additional information is used to determine a finer granularity position;
Assisted GNSS. GNSS information is retrieved by the WD, supported by assistance information provided to the WD from E-SMLC;
OTDOA (Observed Time Difference of Arrival). The WD estimates the time difference of reference signals from different base stations and sends to the enhanced serving mobile location center (E-SMLC) for multilateration;
UTDOA (Uplink Time difference of arrival). The WD is requested to transmit a specific waveform that is detected by multiple location measurement units (e.g., an eNB) at known positions. These measurements are forwarded to the E-SMLC for multilateration.

Recent enhancements in Global Navigation Satellite Signal (GNSS) technology include Real Time Kinematic (RTK) GNSS, which is a differential GNSS positioning technology which enables positioning accuracy improvement from meter level to decimeter or even centimeter level in the right conditions in real-time by exploiting the carrier phase of the GNSS signal rather than only the code phase. Support for RTK GNSS in LTE networks may therefore be provided and are under standardization in the 3GPP Technical Release 15 (3GPP Rel-15) work item (WI). The support for RTK in LTE networks includes providing RTK correction data as part of positioning assistance data to the WD via LTE Positioning Protocol (LPP). Three provisioning arrangements of positioning assistance data to the WD are supported:
Unicast via a user plane connection;
Unicast via a control plane connection; and
Broadcast via system information broadcast.

The unicast provisioning is also supported by NR devices, while NR broadcast is also a plausible enhancement that can be specified.

For unicast, the location server is made aware of the logical position of the target device, such as the tracking area, identity of the serving cell, etc. The logical position information of the target device is used in the location server to determine how to compile the positioning assistance data, which optionally can be periodically provided.

Real-Time Kinematic (RTK) is a technique used to enhance the precision of position data derived from Assisted Global Navigation Satellite System such as GPS, Global Navigation Satellite System (GLONASS), Galileo, NavIC and BeiDou.

The Location Management Function (LMF) is the network entity in the 5G Core Network (5GC) supporting the following functionality:
Supports location determination for a WD;
Obtains downlink location measurements or a location estimate from the WD;
Obtains uplink location measurements from the Next Generation Radio Access Network (NG RAN); and
Obtains non-WD associated assistance data from the NG RAN.

The Enhanced Serving Mobile Location Centre (E-SMLC) performs the same task in the Evolved Packet Core (EPC). A core value of the A-GNSS positioning is that the positioning server (which is the location management function (LMF) in 5G systems, and which is the E-SMLC in 4G systems) provides assistance data to a WD equipped with A-GNSS and may provide support for several purposes:
Increased accuracy;
Increased receiver sensitivity, by providing the receiver with small search fields to focus on;
Reduces power consumption, since the receiver only needs to operate during a positioning procedure; and/or
Shortens Time To First Fix (TTFF), by providing the receiver with accurate assistance data about which satellites can be found and where to find them.

### SUMMARY

Some embodiments advantageously provide methods, systems, and apparatuses for enhanced Assisted Global Navigation Satellite System (A-GNSS) real-time kinematic (RTK) positioning in 3^{rd} Generation Partnership Project (3GPP) Fifth Generation (5G, also called New Radio or NR) network by transferring neighbor cell information.

In some embodiments, a network node is configured to receive a positioning assistance data request from the WD, the positioning assistance data request comprising a first cell identification (ID) and at least one second cell ID; use the at least one second cell ID to generate the positioning assistance data when assistance data is unavailable using the first cell ID; and optionally, send the positioning assistance data to the WD.

In some embodiments, a WD is configured to send a positioning assistance data request to a location server, the positioning assistance data request comprising a first cell identification (ID) and at least one second cell ID; and receive the positioning assistance data, the positioning assistance data being based on at least one of the first cell ID and the at least one second cell ID.

According to one aspect, a location server is configured to communicate with a wireless device, WD. The location server includes a radio interface configured to receive a request from the WD for positioning assistance data, the request identifying each of a plurality of cells, and transmit positioning assistance data to the WD. The location server includes a memory in communication with the radio interface, the memory configured to store positioning assistance data for each cell of a subset of the plurality of cells, the positioning assistance data for a cell being configured to assist a WD to determine a position of the WD. The location server further includes processing circuitry in communication with the radio interface and the memory, the processing circuitry configured to determine whether positioning assistance data for a first cell of the identified cells is stored in the memory. When the positioning assistance data for the first cell is stored in the memory, the radio interface is caused to transmit the positioning assistance data for the first cell to the WD. When the positioning assistance data for the first cell is not stored in the memory, then whether positioning assistance data for a second cell of the identified cells is stored in memory is determined.

According to one aspect, in some embodiments, the processing circuitry is further configured to, when the positioning assistance data for the first cell is unavailable for using a first cell ID, determine positioning assistance data using at least one second cell ID. In some embodiments, the processing circuitry is further configured to, when the positioning assistance data for the second cell is stored in the memory, cause the radio interface to transmit the positioning assistance data for the second cell. In some embodiments, positioning assistance data for a cell includes satellite location data usable by the WD to find at least one global positioning system satellite. In some embodiments, for each identified cell, the request includes a corresponding measure of one of a power and a quality of a signal received by the WD from a network node serving the identified cell. In some embodiments, the processing circuitry is further configured to select for transmission, position assistance data for a cell identified by the WD as providing one of a greatest signal power and a quality of any of the identified cells. In some embodiments, the processing circuitry is further configured to prioritize the identified cells according to one of a power and a quality of a signal received by the WD for each identified cell.

According to another aspect, a method in a location server configured to communicate with a wireless device is provided. The method includes receiving a request from the WD for positioning assistance data, the request identifying each of a plurality of cells, and transmitting positioning assistance data to the WD. The method also includes determining whether positioning assistance data for a first cell of the identified cells is stored in the memory. The method further includes when the positioning assistance data for the first cell is stored in the memory, then transmitting the positioning assistance data for the first cell to the WD. The method also includes when the positioning assistance data for the first cell is not stored in the memory, then determining whether positioning assistance data for a tracking area code associated with the WD location is stored in memory.

According to this aspect, in some embodiments, the method also includes, when the positioning assistance data for the first cell is unavailable for using a first cell ID, determine positioning assistance data using at least one second cell ID. In some embodiments, the method also includes, when the positioning assistance data for the second cell is stored in the memory, transmitting the positioning assistance data for the second cell. In some embodiments, the method also includes, when the positioning assistance data for the TAC is stored in the memory, transmitting the positioning assistance data for the TAC. In some embodiments, positioning assistance data for a cell or TAC includes location data usable by the WD to find at least one global positioning system satellite. In some embodiments, for each identified cell, the request includes a corresponding measure one of a of power and a quality of a signal received by the WD from a network node serving the identified cell. In some embodiments, the method further includes selecting for transmission, position assistance data for a cell identified by the WD as providing one of a greatest signal power and a quality of any of the identified cells. In some embodiments, the method also includes prioritizing the identified cells according to one of a power and a quality of a signal received by the WD for each identified cell.

According to yet another aspect, a WD is configured to communicate with a location server. The WD includes a radio interface configured to: transmit a request to the location server for position assistance data for at least one cell of a plurality of cells identified by at least one of the request and a plurality of cells identified by a tracking area code, and receive positioning assistance data for at least one of the identified cells. The WD also includes processing circuitry in communication with the radio interface. The processing circuitry is configured to determine a position of the WD based at least in part on the received positioning assistance data.

According to this aspect, in some embodiments, the processing circuitry is further configured to prioritize the identified cells according to one of a power and a quality of a received signal for each identified cell. In some embodiments, the radio interface is further configured to transmit one of a power and a quality of a received signal from each identified cell. In some embodiments, the processing circuitry is further configured to find a global positioning system satellite based at least in part on the received positioning assistance data.

According to another aspect, a method in a wireless device, WD, configured to communicate with a location server is provided. The method includes transmitting a request to the location server for position assistance data for at least one cell of a plurality of cells identified by at least one of the request and a plurality of cells identified by a tracking area code. The method also includes receiving positioning assistance data for at least one of the identified cells. The method further includes determining a position of the WD based at least in part on the received positioning assistance data.

According to this aspect, in some embodiments, the method also includes prioritizing the identified cells according to one of a power and a quality of a received signal for each identified cell. In some embodiments, the method also includes transmitting one of a power and a quality of a received signal from each identified cell. In some embodiments, the method includes finding a global positioning system satellite based at least in part on the received positioning assistance data.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example of WD positioning architecture;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a network node according to some embodiments of the present disclosure;

FIG. 9 is a flowchart of an example process in a wireless device according to some embodiments of the present disclosure;

FIG. 10 is an example positioning scenario according to some embodiments of the present disclosure;

FIG. 11 is an example flowchart of an example process in a wireless device according to some embodiments of the present disclosure;

FIG. 12 is an example flowchart of an example process in a wireless device according to some embodiments of the present disclosure;

FIG. 13 is a flowchart of an example process in a network node according to some embodiments of the present disclosure;

FIG. 14 is a flowchart of an example process in a network node according to some embodiments of the present disclosure;

FIG. 15 is a flowchart of another example process in a network node according to principles disclosed herein;

FIG. 16 is a flowchart of another example process in a WD according to principles disclosed herein; and

FIG. 17 is an example call flow diagram according to some embodiments of the present disclosure.

### DETAILED DESCRIPTION

Before describing in detail example embodiments, it is noted that the embodiments reside primarily in combinations of apparatus components and processing steps related to enhanced A-GNSS RTK positioning in 5G network by transferring neighbor cell information. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide enhanced A-GNSS RTK positioning in 5G network by transferring assistance data from a neighboring cell. The assistance data is generated based on the serving cell information which is saved in the database (DB) of the positioning server.

In traditional A-GNSS positioning, (for example, A-GNSS positioning in LTE), if the positioning server (for example, the serving mobile location center (SMLC) in LTE) is not able to find the serving cell of the WD in the DB, it will use the neighbor cells' information to build the reference data for the WD.

However, it may not be possible to find the neighbor cell in 5G based on the current 3GPP solution. If the serving cell cannot be found from the LMF database, this limitation (based on the current 3GPP) has a high possibility to lead to a A-GNSS positioning failure especially during RTK (Real-Time Kinematic) positioning, because the WD may have to change the serving cell frequently in RTK A-GNSS positionings.

A limitation in the current 5G 3GPP Specifications is as follows:

3GPP Technical Specification (TS) 29.272 Version (V) 16.3 defines the serving cell NR cell identity that is to be included in the DetermineLocation Request message. However, when the Location Management Function (LMF) database does not have a same cell identity, it will cause the LMF not to be able to decode the global cell identity (i.e., the NR Cell Identity (NCI) from the DetermineLocation message) to gNBid+cellid. Because the gNBid (for 5G) does not have fixed positions in the NCT. The NR Cell Identity (NCI) is a 36-bit integer which includes gNBId (22-32 bits) and cellId. Thus, if only the NCI is known, gNBId+cell cannot be extracted to get the neighbor cell in the LMF DB, unless the gNBId length is known.

Also, for cases where the gNBid can be determined, cells in one gNB can be distributed over a large area and it may not be possible to determine which neighbor cell(s) are closest to the WD. In an Evolved Packet Core (EPC), there is the same limitations since the eNBId may have a length that is different from an E-UTRAN cell identity (ECI).

A reason for the LMF to not have serving cell information may be, for example a lack of an NR positioning protocol A (NRPPa) interface or delayed update from gNBs to the LMF via either NRPPa or operations, administration and maintenance (OAM). Further, because of rehoming of a base station, the cell information may be incorrect or missing.

Furthermore, this is a radio access technology (RAT) independent positioning method and the LMF may not have implemented the RAT dependent positioning method such as enhanced cell identity (ECID).

In some embodiments, the location/positioning server (hereinafter referred to as the location server) indicates the capability (periodic assistance data control parameters (PeriodicAssistanceDataControlParameters)) of supporting enhanced cell measurement information while providing assistance data (CommonIEsProvideAssistanceData).

In some embodiments, the WD indicates the capability (periodic assistance data control parameters (PeriodicAssistanceDataControlParameters)) of providing enhanced cell measurement information while requesting assistance data (CommonIEsRequestAssistanceData).

In some embodiments, the WD provides the neighbor cell information and may also include the measurements sent to the positioning server (LMF) in a RequestAssisstanceData message each time when the “Periodic assistance data transfer procedure” is triggered.

In some embodiments, the measured neighbor cells may be ordered by the measured signal strength.

Some embodiments of the solution described herein may improve the A-GNSS RTK positioning success rate in the 5G network by, for example helping customers obtain improved accurate positioning results, as compared to existing arrangements.

Some embodiments of the proposed solution may avoid positionings fallback to WD standalone GNSS when, for example, the WD cannot obtain good reference data from the network. Significant time and power resources are consumed for the WD to perform autonomous GPS positioning.

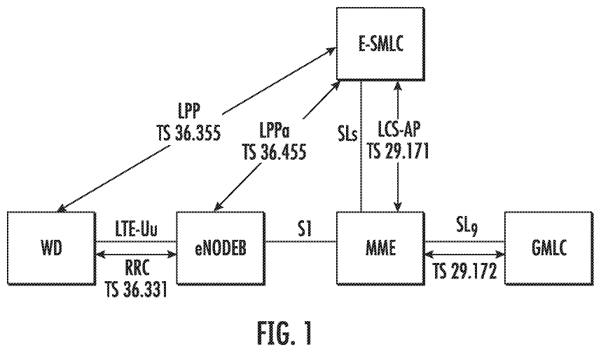

Referring again to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

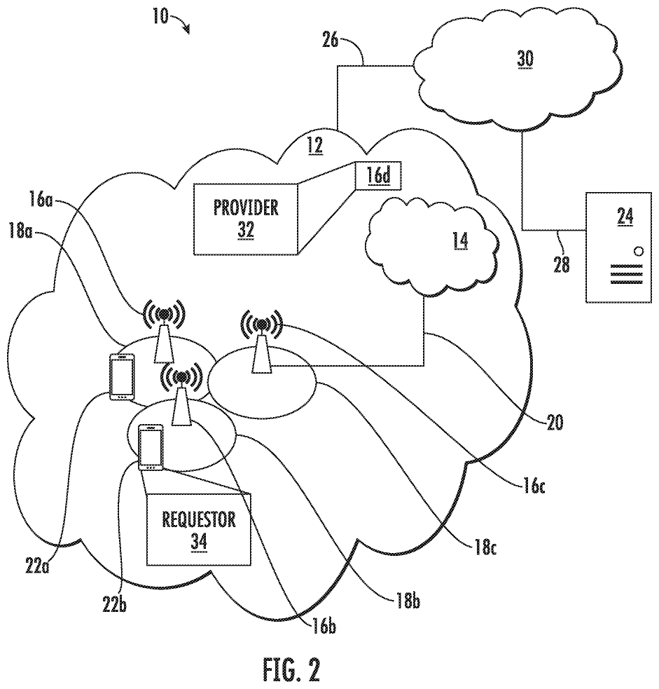

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a provider unit 32 which is configured to determine whether positioning assistance data for a first cell of the identified cells is stored in the memory and when the positioning assistance data for the first cell is stored in the memory, then the provider unit causes the radio interface to transmit the positioning assistance data for the first cell to the WD. When the positioning assistance data for the first cell is not stored in the memory, then the provider unit determines whether positioning assistance data for a second cell of the identified cells is stored in memory.

A wireless device 22 is configured to include a requestor unit 34 which is configured to transmit a request to the location server for position assistance data for at least one cell of a plurality of cells identified by at least one of the request and a plurality of cells identified by a tracking area code.

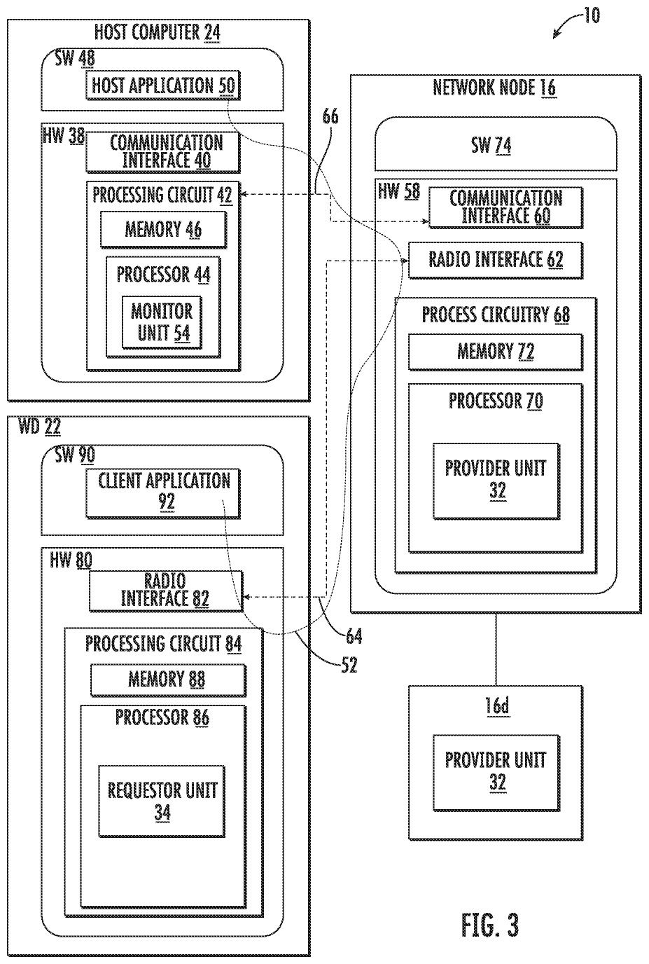

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

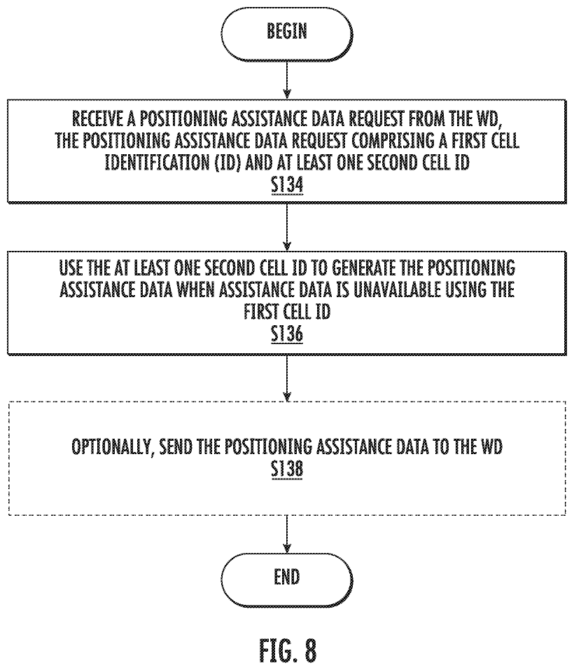

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include provider unit 32 configured to perform network node methods discussed herein, such as the methods discussed with reference to FIG. 8 as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

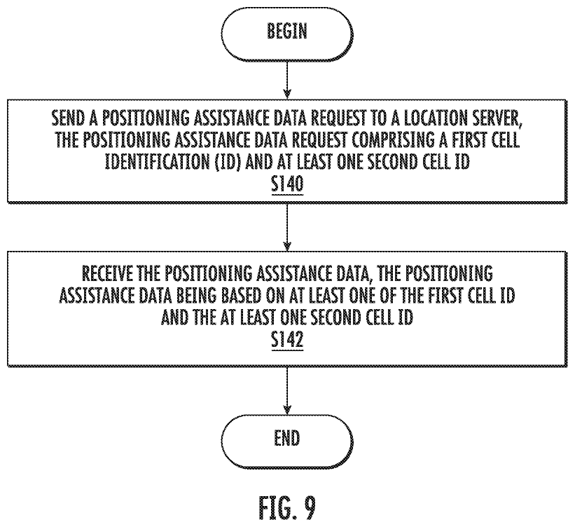

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a requestor unit 34 configured to perform WD methods discussed herein, such as the methods discussed with reference to FIG. 9 as well as other figures.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as provider unit 32, and requestor unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

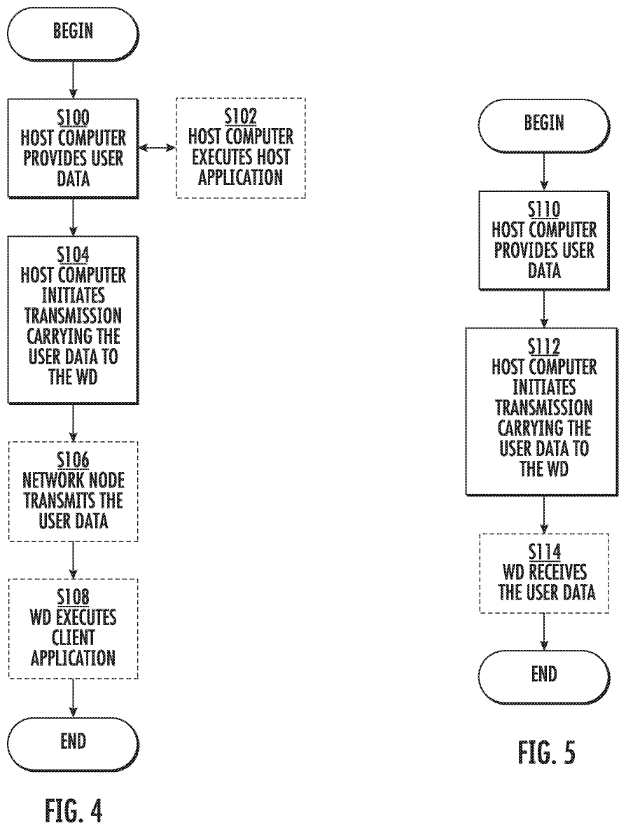

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

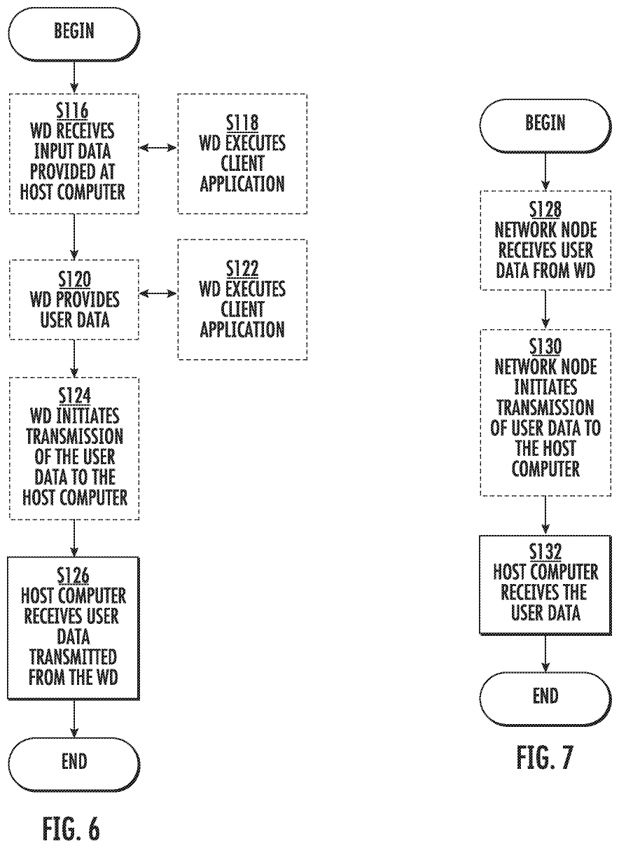

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 8 is a flowchart of an example process in a network node 16 (e.g., location server) according to some embodiments of the present disclosure. One or more Blocks and/or functions and/or methods performed by the network node 16 may be performed by one or more elements of network node 16 such as by provider unit 32 in processing circuitry 68, processor 70, radio interface 62, etc. according to the example method. The example method includes receiving (Block S134), such as via provider unit 32, processing circuitry 68, processor 70 and/or radio interface 62, a positioning assistance data request from the WD, the positioning assistance data request comprising a first cell identification (ID) and at least one second cell ID. The method includes using (Block S136), such as via provider unit 32, processing circuitry 68, processor 70 and/or radio interface 62, the at least one second cell ID to generate the positioning assistance data when assistance data is unavailable using the first cell ID. The method includes optionally, sending (Block S138), such as via provider unit 32, processing circuitry 68, processor 70 and/or radio interface 62, the positioning assistance data to the WD.

FIG. 9 is a flowchart of an example process in a wireless device 22 according to some embodiments of the present disclosure. One or more Blocks and/or functions and/or methods performed by WD 22 may be performed by one or more elements of WD 22 such as by requestor unit 34 in processing circuitry 84, processor 86, radio interface 82, etc. The example method includes sending (Block S140), such as via requestor unit 34, processing circuitry 84, processor 86 and/or radio interface 82, a positioning assistance data request to a location server, the positioning assistance data request comprising a first cell identification (ID) and at least one second cell ID. The method includes receiving (Block S142), such as via requestor unit 34, processing circuitry 84, processor 86 and/or radio interface 82, the positioning assistance data, the positioning assistance data being based on at least one of the first cell ID and the at least one second cell ID.

Having described the general process flow of arrangements of the disclosure and having provided examples of hardware and software arrangements for implementing the processes and functions of the disclosure, the sections below provide details and examples of arrangements for enhanced A-GNSS RTK positioning in 5G network by transferring neighbor cell information, which may be implemented by the network node 16, wireless device 22 and/or host computer 24.

In some embodiments, the first cell ID is an ID of a cell serving the WD and the at least one second cell ID comprises at least one neighbor cell ID. In some embodiments, at least one of: the at least one neighbor cell ID comprises a list of neighbor cell IDs ordered according to a signal strength associated with the respective neighbor cell; the positioning assistance data request further comprises a tracking area code associated with a cell serving the WD; and using the at least one second cell ID further comprises using a neighbor cell ID in the list that is associated with a highest signal strength first.

In some embodiments, the first cell ID is an ID of a cell serving the WD and the at least one second cell ID comprises at least one neighbor cell ID. In some embodiments, at least one of: the at least one neighbor cell ID comprises a list of neighbor cell IDs ordered according to a signal strength associated with the respective neighbor cell; and the positioning assistance data request further comprises a tracking area code associated with a cell serving the WD.

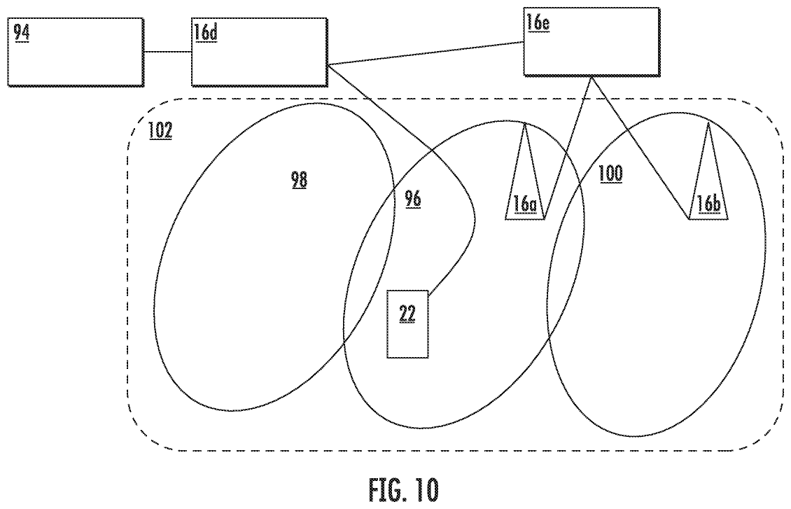

As an example, some embodiments related to the positioning scenario in FIG. 10, with a target device WD 22 supported by a location server (e.g., network node (NN) 16d), configured to provide periodic positioning assistance data, optionally from an assistance data provider 94. WD 22 is served by (or camping at) a first radio network node (e.g., NN 16a) associated to a first logical position information (for example a cell ID), and the first radio network node (e.g., NN 16a) provides communication services in a first cell 96. In this example, the WD 22 has a neighbor cell 98 in the same radio node and another neighbor cell 100 served by a second radio network node 16b associated to a second logical position information and providing communication services in the second neighbor cell 100. Furthermore, the network nodes 16a and 16b, e.g., base stations, are associated to a core network node (e.g., NN 16e), which may route messages between the WD 22 and the location server (e.g., NN 16d) via the serving base station (e.g., NN 16a or NN 16b). The core network node (e.g., NN 16e) also may interact with the base stations (e.g., NN 16a and NN 16b), while the base stations (e.g., NN 16a and NN 16b) may have a direct signaling interface. The location server (e.g., NN 16d) lacks the information about the serving cell 96 in its database; however, the location server (e.g., NN 16d) may have information about another neighbor cell 98 or 100 in its database. Furthermore, cells are grouped by a tracking area code for a tracking area 102, where all cells in the same group are associated to the same tracking area code, or possibly the same tracking area code list.

Table 1 provides examples of information elements that can be considered for periodic positioning assistance data.

TABLE 1
Example Information Elements for periodic positioning assistance data.
assistanceDataElement

GNSS-ReferenceTime
GNSS-ReferenceLocation
GNSS-IonosphericModel
GNSS-EarthOrientationParameters
GNSS-RTK-ReferenceStationInfo
GNSS-RTK-CommonObservationInfo
GNSS-RTK-AuxiliaryStationData
GNSS-TimeModelList
GNSS-DifferentialCorrections
GNSS-NavigationModel
GNSS-RealTimeIntegrity
GNSS-DataBitAssistance
GNSS-AcquisitionAssistance
GNSS-Almanac
GNSS-UTC-Model
GNSS-AuxiliaryInformation
BDS-DifferentialCorrections
BDS-GridModelParameter
GNSS-RTK-Observations
GLO-RTK-BiasInformation
GNSS-RTK-MAC-CorrectionDifferences
GNSS-RTK-Residuals
GNSS-RTK-FKP-Gradients
GNSS-SSR-OrbitCorrections
GNSS-SSR-ClockCorrections
GNSS-SSR-CodeBias

For GNSS RTK, the information of any one or more of these information elements may be associated to physical or non-physical reference stations, each identified by a reference station identification (ID) defined in, for example, GNSS-RTK-ReferenceStationInfo. Related observations may be provided frequently such as once per second, for example, via GNSS-RTK-CommonObservationInfo and GNSS-R TK-Observations. These observations are associated to reference station IDs.

In some embodiments, when the WD 22 provides the logical position information along with neighbor cell logical information, the location server (e.g., NN 16d) may verify the presence of any of this logical positioning information. The location server (e.g., NN 16d) may prioritize the serving cell logical information and may try to map the GNSS assistance data matching this serving cell logical information. However, if the location server (e.g., NN 16d) does not find the serving cell ID in its database then the location server would search for neighbor cell information. In some embodiments, it may be expected that the WD 22 provides the neighbor cell information in ascending or descending order of signal strength. Further, the WD 22 may provide the absolute value of the signal strength such as reference signal received power (RSRP), signal-to-interference-plus-noise ratio (SINR) or signal quality such as reference signal received quality (RSRQ). Thus, the location server (e.g., NN 16d) may search for the cells in signal strength descending order (neighbor cell with highest signal strength first). If the location server (e.g., NN 16d) finds a neighbor cell, the location server (e.g., NN 16d) may generate the assistance data accordingly.

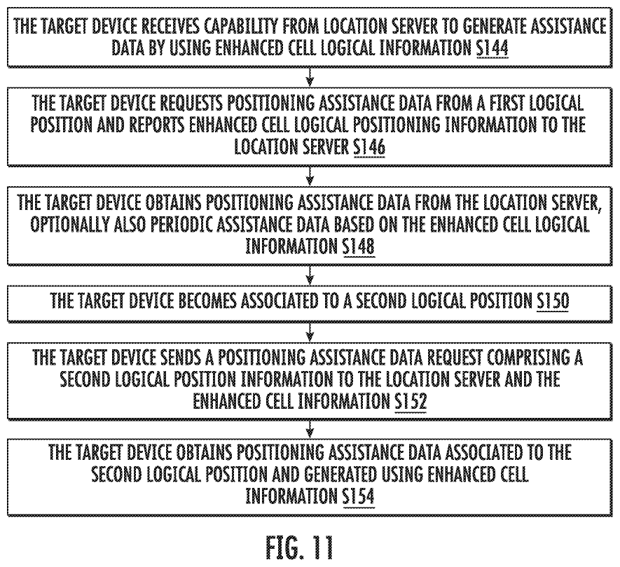

FIG. 11 is a flowchart of an example process in a wireless device 22 according to some embodiments of the present disclosure. One or more blocks described herein may be performed by one or more elements of wireless device 22 such as by one or more of processing circuitry 84 (including the requestor unit 34), processor 86, radio interface 82 and/or communication interface 60. Wireless device 22 such as via processing circuitry 84 and/or processor 86 and/or radio interface 82 is configured to receive (S144) capability information from a location server (e.g., NN 16d) to generate assistance data by using enhanced cell logical information. The method includes requesting (S146) positioning assistance data from a first logical position and reporting enhanced cell logical positioning information to the location server (e.g., NN 16d). The method includes obtaining (S148) positioning assistance data from the location server (e.g., NN 16d), and optionally also periodic assistance data based on the enhanced cell logical information. The method includes (S150) becoming associated to a second logical position. The method includes sending (S152) a positioning assistance data request comprising a second logical position information to the location server (e.g., NN 16d) and the enhanced cell information. The method includes obtaining (S154) positioning assistance data associated to the second logical position and generated using the enhanced cell information.

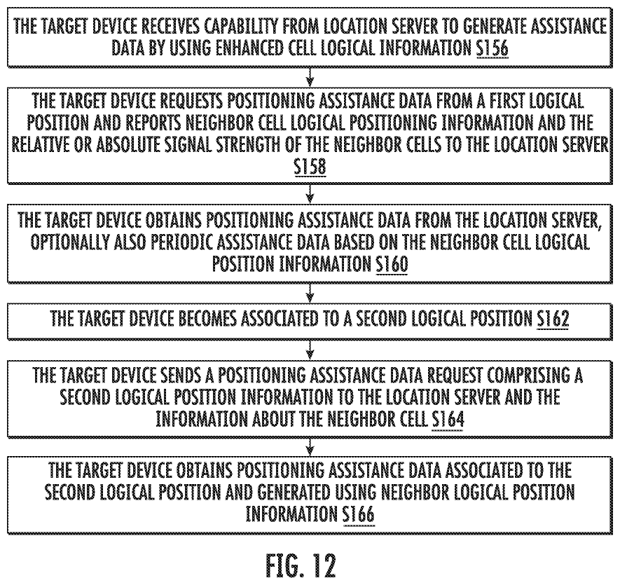

FIG. 12 illustrates another example method that may be performed by a WD 22. The method includes receiving (S156) capability information from a location server (e.g., NN 16d) to generate assistance data by using neighbor cell logical information. The method includes requesting (S158) positioning assistance data from a first logical position and reporting neighbor cell logical positioning information and the relative or absolute signal strength of the neighbor cells to the location server (e.g., NN 16d). The method includes obtaining (S160) positioning assistance data from the location server (e.g., NN 16d) and optionally, also periodic assistance data based on the neighbor cell logical position information. The method includes becoming (S162) associated to a second logical position. The method includes sending (S164) a positioning assistance data request comprising a second logical position information to the location server (e.g., NN 16d) and the information about the neighbor cell. The method includes obtaining (S166) positioning assistance data associated to the second logical position and generated using neighbor logical position information.

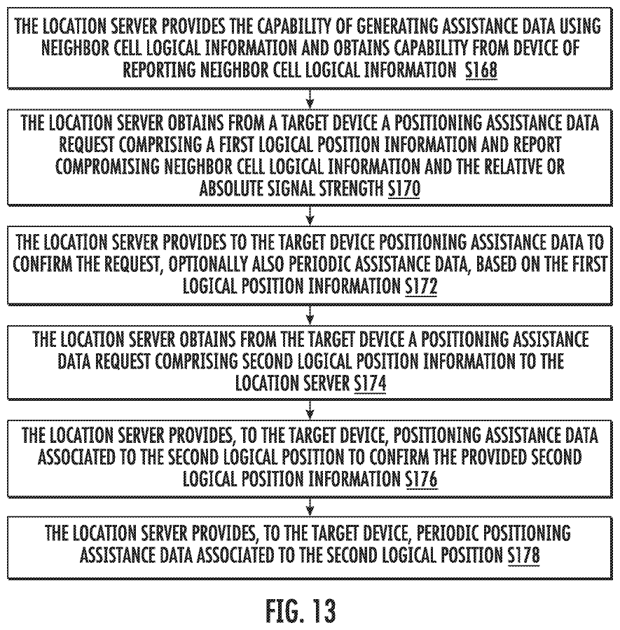

FIG. 13 is a flowchart of an example process in a network node 16 configured to function as a location server. One or more blocks described herein may be performed by one or more elements of network node 16 such as by one or more of processing circuitry 68 (including the provider unit 32), processor 70, radio interface 62 and/or communication interface 60. Network node 16 such as via processing circuitry 68 and/or processor 70 and/or radio interface 62 and/or communication interface 60 is configured to provide (S168) the capability of generating assistance data using neighbor cell logical information and obtaining capability from a WD 22 of reporting neighbor cell logical information. The method includes obtaining (S170) from a target WD 22 a positioning assistance data request comprising a first logical position information and a report comprising neighbor cell logical information and the relative or absolute signal strength. The method includes providing (S172) the target WD 22 positioning assistance data to confirm the request and optionally also periodic assistance data, based on the first logical position information. The method includes obtaining (S174) from the target WD 22 a positioning assistance data request comprising second logical position information. The method includes providing (S176), to the target WD 22, positioning assistance data associated to the second logical position to confirm the provided second logical position information. The method includes providing (S178), to the target WD 22, periodic positioning assistance data associated to the second logical position.

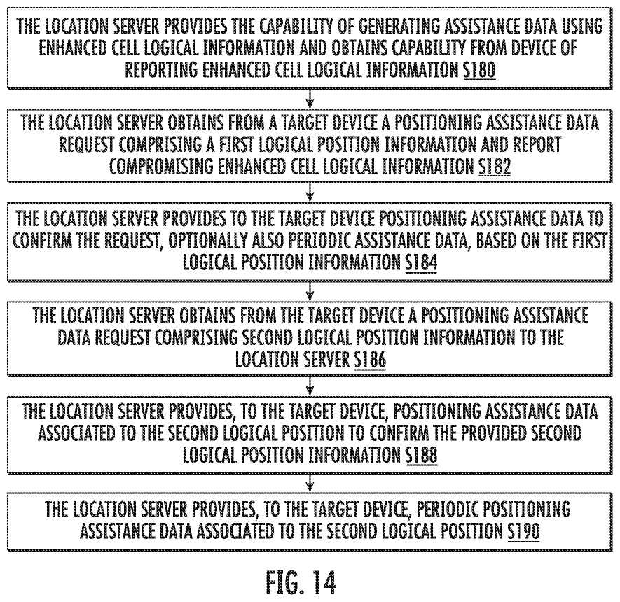

FIG. 14 illustrates another example method that may be performed by a location server (e.g., NN 16d). The method includes providing (S180) the capability of generating assistance data using enhanced cell logical information and obtaining capability from the WD 22 of reporting enhanced cell logical information. The method includes obtaining (S182) from a target WD 22 a positioning assistance data request comprising a first logical position information and a report comprising enhanced cell logical information. The method includes providing (S184) to the target WD 22 positioning assistance data to confirm the request and optionally also periodic assistance data, based on the first logical position information. The method includes obtaining (S186) from a target WD 22 a positioning assistance data request comprising second logical position information. The method includes providing (S188) to the target WD 22 positioning assistance data associated to the second logical position to confirm the provided second logical position information. The method includes providing (S190) to the target WD 22 periodic positioning assistance data associated to the second logical position.

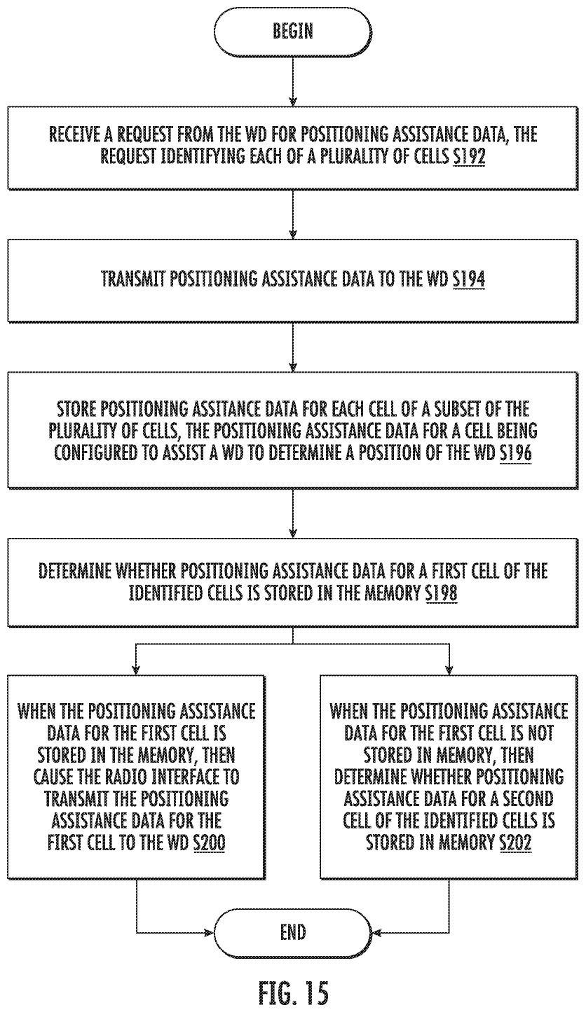

FIG. 15 is a flowchart of an example process in a network node 16 configured to function as a location server. One or more blocks described herein may be performed by one or more elements of network node 16 such as by one or more of processing circuitry 68 (including the provider unit 32), processor 70, radio interface 62 and/or communication interface 60. Network node 16 such as via processing circuitry 68 and/or processor 70 and/or radio interface 62 and/or communication interface 60 is configured to receive a request from the WD for positioning assistance data, the request identifying each of a plurality of cells (Block S194). The process also includes transmitting positioning assistance data to the WD (Block S196). The process further includes determining whether positioning assistance data for a first cell of the identified cells is stored in the memory (Block S198). The process also includes, when the positioning assistance data for the first cell is stored in the memory, then transmitting the positioning assistance data for the first cell to the WD (Block S200). The process further includes when the positioning assistance data for the first cell is not stored in the memory, then determining whether positioning assistance data for a tracking area code associated with the WD location is stored in memory (Block S202).

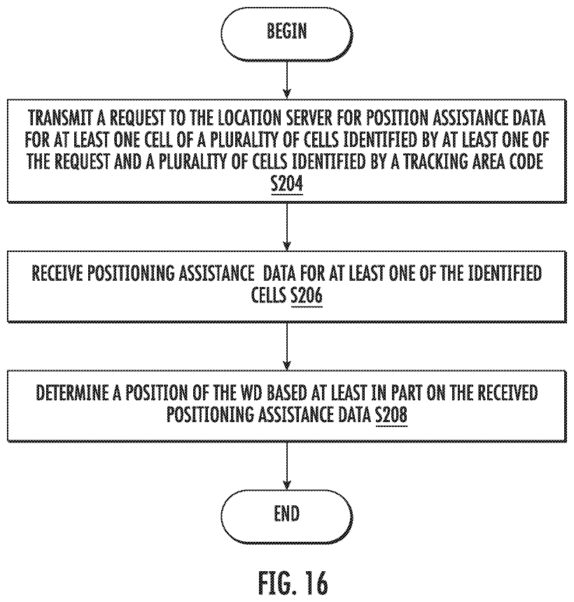

FIG. 16 is a flowchart of an example process in a wireless device 22 according to some embodiments of the present disclosure. One or more blocks described herein may be performed by one or more elements of wireless device 22 such as by one or more of processing circuitry 84 (including the requestor unit 34), processor 86, radio interface 82 and/or communication interface 60. Wireless device 22 such as via processing circuitry 84 and/or processor 86 and/or radio interface 82 is configured to transmit a request to the location server for position assistance data for at least one cell of a plurality of cells identified by at least one of the request and a plurality of cells identified by a tracking area code (Block S204). The process also includes receiving positioning assistance data for at least one of the identified cells (Block S206). The process further includes determining a position of the WD based at least in part on the received positioning assistance data (Block S208).

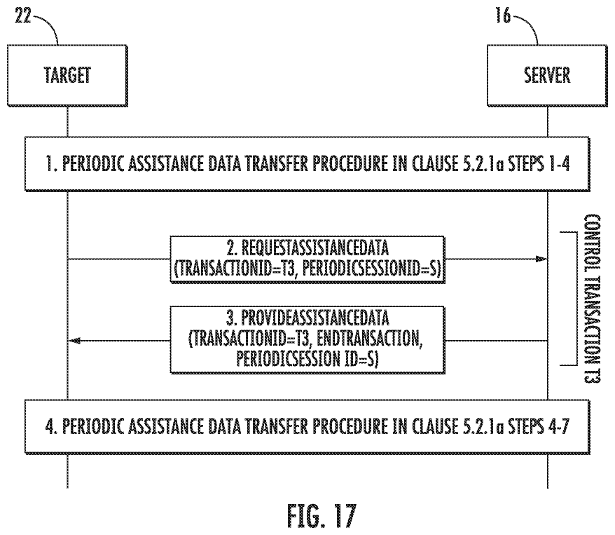

Below are section details for example specification changes to 3GPP TS 37.355 to implement some embodiments of the present disclosure. FIG. 17 shows an example modified arrangement based on Chapter 5.2.2 of 3GPP TS 37.355 V15.5.

The change is highlighted in bold below:
1. Steps 1-2, and optionally steps 3-4, from FIG. 15 are performed for the Periodic Assistance Data Transfer procedure in clause 5.2.1a with the following exceptions:
   The RequestAssistanceData message in step 1 indicates the update capabilities of the target device.
   The ProvideAssistanceData message in step 2 indicates the update capabilities of the target device which are supported by the server.
2. If the target device changes its primary cell and if the update capabilities of the target device supported by the server in step 1 includes update of a primary cell ID, the target device sends a RequestAssistanceData message to the server using some available transactionID T3, which is different from T2 (previously used in step 2). The message contains the periodicSessionID S (previously used in step 1), the new primary cell ID and enhanced cell ID in the information element (IE) CommonIEsRequestAssistanceData.

The enhanced cell ID may include different enhancements in different embodiments, such as one or more of the following:
neighbor cell identifiers, same radio access technology as the primary cell ID;
neighbor cell identifiers sorted in measured received signals strength order, same radio access technology as the primary cell ID;
neighbor cell identifiers, same and/or different radio access technology as the primary cell ID;
neighbor cell identifiers sorted in measured received signals strength order, same and/or different radio access technology as the primary cell ID;
tracking area code information associated to the primary cell ID; and/or
tracking area code information associated to a configured cell at the same or at a different radio access technology.

A figure based on chapter 6.4.2 of 3GPP TS 37.355 v16.2.0 may be related to some embodiments disclosed herein.

After the enhancement, the neighbor cell list may be provided in “Request Assistance Data” during the “Periodic assistance data transfer procedure”. The neighbor cell list may be determined and/or ordered by the signal strength of each neighbour cell indicated by the respective neighbour cell ID. The WD 22 may report all the measured neighbour cells in the CommonIEsRequestAssistanceData message.

One example, for an update to the message format according to some embodiments disclosed herein is as follows:

CommonIEsRequestAssistanceData

The CommonIEsRequestAssistanceData carries common IEs for a
Request Assistance Data LPP message Type.
-- ASN1START
CommonIEsRequestAssistanceData ::= SEQUENCE {

| | |
|---|---|
| primaryCellID ECGI | OPTIONAL, -- |
| | Cond EUTRA |

```
  ...,
  [[
```

| | |
|---|---|
| segmentationInfo-r14 | SegmentationInfo-r14 |

```
  OPTIONAL -- Cond Segmentation
  ]],
  [[
      periodicAssistanceDataReq-r15
  PeriodicAssistanceDataControlParameters-r15
```

| | |
|---|---|
| | OPTIONAL, -- Cond |
| | PerADreq |
| primaryCellID-r15 | NCGI-r15 |
| OPTIONAL | -- Cond NR |

```
  ]],
  [[
```

| | |
|---|---|
| nr-NeighborCellIDList-r17 | SEQUENCE |
| (SIZE(1..8)) OF NCGI-r15 OPTIONAL, | -- Cond NRCell |
| eutra-NeigborCellIDlist-r17 | SEQUENCE |
| | (SIZE(1..8)) OF |

ECGI OPTIONAL -- Cond EUTRACell

| | |
|---|---|
| epc-TrackingAreaCode | EPC- |
| TrackignAreaCode | OPTIONAL -- |
| | Cond EUTRACell |
| 5gc-TrackingAreaCode | 5GC- |
| TrackignAreaCode | OPTIONAL -- |
| | Cond NRCell |

]]
}
-- ASN1STOP

TABLE 2
Conditional Presence.

| Conditional | |
|---|---|
| presence | Explanation |
| EUTRA | The field is mandatory present for E-UTRA or NB-IoT |
| | access. The field shall be omitted for non-EUTRA and |
| | non-NB-IoT user plane support. |
| Segmentation | This field is optionally present, need OP, if lpp- |
| | message-segmentation-req has been received from the |
| | location server with bit 1 (targetToServer) set to value |
| | 1. The field shall be omitted if |
| | lpp-message-segmentation-req has not been received in |
| | this location session, or has been received with bit 1 |
| | (targetToServer) set to value 0. |
| PerADreq | The field is mandatory present if the target device |
| | requests periodic assistance data delivery. Otherwise it |
| | is not present. |
| NR | The field is mandatory present for NR access. The field |
| | shall be omitted for non-NR user plane support. |
| EUTRACell | The field is optionally present for E-UTRA or NB- |
| | IoT access. The field shall be omitted for non- |
| | EUTRA and non-NB-IoT user plane support. |
| NRCell | The field is optionally present for NR access. The |
| | field shall be omitted for non-NR user plane |
| | support. |

TABLE 3
Field Descriptions for CommonIEsRequestAssistanceData.
CommonIEsRequestAssistanceData field descriptions

primaryCellID
This parameter identifies the current primary cell for the target device.
segmentationInfo
This field indicates whether this RequestAssistanceData message is one of
many segments, as specified in clause 4.3.5 of 3GPP TS 37.355 v16.2.0.
periodicAssistanceDataReq
This field indicates a request for periodic assistance data delivery, as
specified in clause 5.2.1a of 3GPP TS 37.355 v16.2.0.
nr-NeighborCellIDList
This field indicates a list of neighbor cell NCGI that the target cell
provides in descending order of signal strength.
eutra-NeighborCellIDList
This field indicates a list of neighbor cell ECGI that the target cell
provides in descending order of signal strength.

The above condition EUTRACell and NRCell may impose an optional requirement on the WD 22. However, from the network (NW) perspective, rather than optional reporting, a mandatory reporting from the WD 22 may be desired. In such case, the signalling may be modified to include the following:

nr-NeighborCellIDList-r17 SEQUENCE (SIZE(1..8)) OF NCGI-r15
OPTIONAL,-- Cond NR
eutra-NeigborCellIDlist-r17SEQUENCE (SIZE(1..8)) OF ECGI
OPTIONAL -- Cond EUTRA.

In some embodiments, the tracking area for EPC and 5G core may be defined as below:
TrackingAreaCode
The IE TrackingAreaCode is used to identify a tracking area within the scope of a public land mobile network (PLMN), see 3GPP TS 24.301.

```
-- ASN1START
  EPC-TrackingAreaCode ::= BIT STRING (SIZE (16))
  5GC-TrackingAreaCode ::= BIT STRING (SIZE (24))
-- ASN1STOP
```

An example capability update according to some embodiments is shown below.

PeriodicAssistanceDataControlParameters

The IE PeriodicAssistanceDataControlParameters is used in a periodic assistance data delivery procedure as described in clauses 5.2.1a and 5.2.2a.

-- ASN1START
PeriodicAssistanceDataControlParameters-r15 ::= SEQUENCE {

| | |
|---|---|
| periodicSessionID-r15 | PeriodicSessionID-r15, |

```
  ...,
  [[
```

| | |
|---|---|
| updateCapabilities-r15 | UpdateCapabilities-r15 |

```
  OPTIONAL
  ]]
}
PeriodicSessionID-r15 ::= SEQUENCE {
```

| | |
|---|---|
| periodicSessionInitiator-r15 | ENUMERATED { locationServer, |
| | targetDevice, |

... },

| | |
|---|---|
| periodicSessionNumber-r15 | INTEGER (0..255), |

...
}
UpdateCapabilities-r15 ::= BIT STRING {primaryCellID-r15 (0),

| | |
|---|---|
| | neighborCellID-r17 (1), |
| trackingareacode-r17 | (2)} (SIZE(1..8)) |

-- ASN1STOP

TABLE 4
Field descriptions for IE PeriodicAssistanceDataControlParameters.
PeriodicAssistanceDataControlParameters field descriptions

periodicSessionID
This field identifies a particular periodic assistance data delivery session
and the initiator of the session.
update Capabilities
This field identifies the capabilities of the sending entity to support an
update of periodic assistance data. A bit value set to one indicates a
capability is supported and a bit value set to zero indicates a capability
is not supported.

Some embodiments may be used for emergency positionings. Possibly it may save more lives during emergency positioning, as compared to existing arrangements. Some embodiments of the present disclosure may assist the WD 22 and/or the network with saving significant positioning time compared to standalone GNSS positioning. Some embodiments of the present disclosure may save significant battery costs for WDs.

According to one aspect, a location server 16 is configured to communicate with a wireless device, WD 22. The location server 16 includes a radio interface (62) configured to receive a request from the WD 22 for positioning assistance data, the request identifying each of a plurality of cells, and transmit positioning assistance data to the WD 22. The location server 16 includes a memory (72) in communication with the radio interface, the memory configured to store positioning assistance data for each cell of a subset of the plurality of cells, the positioning assistance data for a cell being configured to assist a WD 22 to determine a position of the WD 22. The location server 16 further includes processing circuitry (68) in communication with the radio interface (62) and the memory (72), the processing circuitry (68) configured to determine whether positioning assistance data for a first cell of the identified cells is stored in the memory. When the positioning assistance data for the first cell is stored in the memory, the radio interface is caused to transmit the positioning assistance data for the first cell to the WD 22. When the positioning assistance data for the first cell is not stored in the memory, then whether positioning assistance data for a second cell of the identified cells is stored in memory is determined.

According to one aspect, in some embodiments, the processing circuitry (68) is further configured to, when the positioning assistance data for the first cell is unavailable for using a first cell ID, determine positioning assistance data using at least one second cell ID. In some embodiments, the processing circuitry (68) is further configured to, when the positioning assistance data for the second cell is stored in the memory, cause the radio interface to transmit the positioning assistance data for the second cell. In some embodiments, positioning assistance data for a cell includes satellite location data usable by the WD 22 to find at least one global positioning system satellite. In some embodiments, for each identified cell, the request includes a corresponding measure of one of a power and a quality of a signal received by the WD 22 from a network node 16 serving the identified cell. In some embodiments, the processing circuitry (68) is further configured to select for transmission, position assistance data for a cell identified by the WD 22 as providing one of a greatest signal power and a quality of any of the identified cells. In some embodiments, the processing circuitry (68) is further configured to prioritize the identified cells according to one of a power and a quality of a signal received by the WD 22 for each identified cell.

According to another aspect, a method in a location server 16 configured to communicate with a wireless device 22 is provided. The method includes receiving a request from the WD 22 for positioning assistance data, the request identifying each of a plurality of cells, and transmitting positioning assistance data to the WD 22. The method also includes determining whether positioning assistance data for a first cell of the identified cells is stored in the memory. The method further includes when the positioning assistance data for the first cell is stored in the memory, then transmitting the positioning assistance data for the first cell to the WD 22. The method also includes when the positioning assistance data for the first cell is not stored in the memory, then determining whether positioning assistance data for a tracking area code associated with the WD 22 location is stored in memory.

According to this aspect, in some embodiments, the method also includes, when the positioning assistance data for the first cell is unavailable for using a first cell ID, determine positioning assistance data using at least one second cell ID. In some embodiments, the method also includes, when the positioning assistance data for the second cell is stored in the memory, transmitting the positioning assistance data for the second cell. In some embodiments, the method also includes, when the positioning assistance data for the TAC is stored in the memory, transmitting the positioning assistance data for the TAC. In some embodiments, positioning assistance data for a cell or TAC includes location data usable by the WD 22 to find at least one global positioning system satellite. In some embodiments, for each identified cell, the request includes a corresponding measure one of a of power and a quality of a signal received by the WD 22 from a network node 16 serving the identified cell. In some embodiments, the method further includes selecting for transmission, position assistance data for a cell identified by the WD 22 as providing one of a greatest signal power and a quality of any of the identified cells. In some embodiments, the method also includes prioritizing the identified cells according to one of a power and a quality of a signal received by the WD 22 for each identified cell.

According to yet another aspect, a WD 22 is configured to communicate with a location server 16. The WD 22 includes a radio interface (82) configured to: transmit a request to the location server 16 for position assistance data for at least one cell of a plurality of cells identified by at least one of the request and a plurality of cells identified by a tracking area code, and receive positioning assistance data for at least one of the identified cells. The WD 22 also includes processing circuitry (84) in communication with the radio interface. The processing circuitry (84) is configured to determine a position of the WD 22 based at least in part on the received positioning assistance data.

According to this aspect, in some embodiments, the processing circuitry (84) is further configured to prioritize the identified cells according to one of a power and a quality of a received signal for each identified cell. In some embodiments, the radio interface (82) is further configured to transmit one of a power and a quality of a received signal from each identified cell. In some embodiments, the processing circuitry (84) is further configured to find a global positioning system satellite based at least in part on the received positioning assistance data.

According to another aspect, a method in a wireless device, WD 22, configured to communicate with a location server 16 is provided. The method includes transmitting a request to the location server 16 for position assistance data for at least one cell of a plurality of cells identified by at least one of the request and a plurality of cells identified by a tracking area code. The method also includes receiving positioning assistance data for at least one of the identified cells. The method further includes determining a position of the WD 22 based at least in part on the received positioning assistance data.

According to this aspect, in some embodiments, the method also includes prioritizing the identified cells according to one of a power and a quality of a received signal for each identified cell. In some embodiments, the method also includes transmitting one of a power and a quality of a received signal from each identified cell. In some embodiments, the method includes finding a global positioning system satellite based at least in part on the received positioning assistance data.

Some embodiments may include the following.

Embodiment A1. A network node configured to communicate with a wireless device (WD), the network node configured to, and/or comprising a radio interface and/or comprising processing circuitry configured to one or more of:
receive a positioning assistance data request from the WD, the positioning assistance data request comprising a first cell identification (ID) and at least one second cell ID;
use the at least one second cell ID to generate the positioning assistance data when assistance data is unavailable using the first cell ID; and
optionally, send the positioning assistance data to the WD.

Embodiment A2. The network node of Embodiment A1, wherein the first cell ID is an ID of a cell serving the WD and the at least one second cell ID comprises at least one neighbor cell ID.

Embodiment A3. The network node of Embodiment A1, wherein at least one of:
the at least one neighbor cell ID comprises a list of neighbor cell IDs ordered according to a signal strength associated with the respective neighbor cell;
the positioning assistance data request further comprises a tracking area code associated with a cell serving the WD; and
the network node and/or the processing circuitry and/or the radio interface is configured to cause the network node to use the at least one second cell ID by being configured to cause the network node to use a neighbor cell ID in the list that is associated with a highest signal strength first.

Embodiment B1. A method implemented in a network node, the method comprising:
receiving a positioning assistance data request from the WD, the positioning assistance data request comprising a first cell identification (ID) and at least one second cell ID;
using the at least one second cell ID to generate the positioning assistance data when assistance data is unavailable using the first cell ID; and
optionally, sending the positioning assistance data to the WD.

Embodiment B2. The method of Embodiment B1, wherein the first cell ID is an ID of a cell serving the WD and the at least one second cell ID comprises at least one neighbor cell ID.

Embodiment B3. The method of any one of Embodiments B1 and B2, wherein at least one of:
the at least one neighbor cell ID comprises a list of neighbor cell IDs ordered according to a signal strength associated with the respective neighbor cell;
the positioning assistance data request further comprises a tracking area code associated with a cell serving the WD; and
using the at least one second cell ID further comprises using a neighbor cell ID in the list that is associated with a highest signal strength first.

Embodiment C1. A wireless device (WD) configured to communicate with a network node, the WD configured to, and/or comprising a radio interface and/or processing circuitry configured to one or more of:
send a positioning assistance data request to a location server, the positioning assistance data request comprising a first cell identification (ID) and at least one second cell ID; and
receive the positioning assistance data, the positioning assistance data being based on at least one of the first cell ID and the at least one second cell ID.

Embodiment C2. The WD of Embodiment C1, wherein the first cell ID is an ID of a cell serving the WD and the at least one second cell ID comprises at least one neighbor cell ID.

Embodiment C3. The WD of any one of Embodiments C1 and C2, wherein at least one of:
the at least one neighbor cell ID comprises a list of neighbor cell IDs ordered according to a signal strength associated with the respective neighbor cell; and
the positioning assistance data request further comprises a tracking area code associated with a cell serving the WD.

Embodiment D1. A method implemented in a wireless device (WD), the method comprising:
sending a positioning assistance data request to a location server, the positioning assistance data request comprising a first cell identification (ID) and at least one second cell ID; and
receiving the positioning assistance data, the positioning assistance data being based on at least one of the first cell ID and the at least one second cell ID.

Embodiment D2. The method of Embodiment D1, wherein the first cell ID is an ID of a cell serving the WD and the at least one second cell ID comprises at least one neighbor cell ID.

Embodiment D3. The method of Embodiment D1, wherein at least one of:
the at least one neighbor cell ID comprises a list of neighbor cell IDs ordered according to a signal strength associated with the respective neighbor cell; and
the positioning assistance data request further comprises a tracking area code associated with a cell serving the WD.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| A-GNSS | Assisted Global Navigation Satellite System |
| LMF | Location Management Function |
| NCI | NR cell identity |
| RTK | Real-Time Kinematic |
| UE | User Equipment |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A location server configured to communicate with a wireless device, WD, the location server comprising:
a radio interface configured to:
receive a request from the WD for positioning assistance data, the request identifying each of a plurality of cells; and
transmit positioning assistance data to the WD;
a memory in communication with the radio interface, the memory configured to store positioning assistance data for each cell of a subset of the plurality of cells, the positioning assistance data for a cell being configured to assist a WD to determine a position of the WD; and
processing circuitry in communication with the radio interface and the memory, the processing circuitry configured to:
determine whether positioning assistance data for a first cell of the identified cells is stored in the memory;
when the positioning assistance data for the first cell is stored in the memory, then cause the radio interface to transmit the positioning assistance data for the first cell to the WD; and
when the positioning assistance data for the first cell is not stored in the memory, then determine whether positioning assistance data for a second cell of the identified cells is stored in memory.

2. The location server of claim 1, wherein the processing circuitry is further configured to, when the positioning assistance data for the first cell is unavailable for using a first cell ID, determine positioning assistance data using at least one second cell ID.

3. The location server of claim 1, wherein the processing circuitry is further configured to, when the positioning assistance data for the second cell is stored in the memory, cause the radio interface to transmit the positioning assistance data for the second cell.

4. The location server of claim 1, wherein the radio interface is further configured to, when the positioning assistance data for a tracking area code (TAC) is stored in the memory, transmit the positioning assistance data for the TAC.

5. The location server of claim 1, wherein positioning assistance data for a tracking area code (TAC) includes satellite location data usable by the WD to find at least one global positioning system satellite.

6. The location server of claim 1, wherein, for each identified cell, the request includes a corresponding measure of one of a power and a quality of a signal received by the WD from a network node serving the identified cell.

7. The location server of claim 1, wherein the processing circuitry is further configured to select for transmission, position assistance data for a cell identified by the WD as providing one of a greatest signal power and a quality of any of the identified cells.

8. The location server of claim 1, wherein the processing circuitry is further configured to prioritize the identified cells according to one of a power and a quality of a signal received by the WD for each identified cell.

9. A method in a location server configured to communicate with a wireless device, WD, the method comprising:
receiving a request from the WD for positioning assistance data, the request identifying each of a plurality of cells; and
transmitting positioning assistance data to the WD;
store positioning assistance data for each cell of a subset of the plurality of cells, the positioning assistance data for a cell being configured to assist a WD to determine a position of the WD;
determining whether positioning assistance data for a first cell of the identified cells is stored in the memory;
when the positioning assistance data for the first cell is stored in the memory, then transmitting the positioning assistance data for the first cell to the WD; and
when the positioning assistance data for the first cell is not stored in the memory, then determining whether positioning assistance data for a tracking area code associated with the WD location is stored in memory.

10. The method of claim 9, further comprising, when the positioning assistance data for the first cell is unavailable for using a first cell ID, determine positioning assistance data using at least one second cell ID.

11. The method of claim 9, further comprising, when the positioning assistance data for the second cell is stored in the memory, transmitting the positioning assistance data for the second cell.

12. The method of claim 9, further comprising, when the positioning assistance data for a tracking area code (TAC) is stored in the memory, transmitting the positioning assistance data for the TAC.

13. The method of claim 9, wherein positioning assistance data for a cell or tracking area code (TAC) includes location data usable by the WD to find at least one global positioning system satellite.

14. The method of claim 9, wherein, for each identified cell, the request includes a corresponding measure one of a of power and a quality of a signal received by the WD from a network node serving the identified cell.

15. The method of claim 9, further comprising selecting for transmission, position assistance data for a cell identified by the WD as providing one of a greatest signal power and a quality of any of the identified cells.

16. The method of claim 9, further comprising prioritizing the identified cells according to one of a power and a quality of a signal received by the WD for each identified cell.

17. A wireless device, WD, configured to communicate with a location server, the WD comprising:
a radio interface configured to:
transmit a request to the location server for position assistance data for at least one cell of a plurality of cells identified by at least one of the request and a plurality of cells identified by a tracking area code; and
receive positioning assistance data for at least one of the identified cells; and
processing circuitry in communication with the radio interface, the processing circuitry configured to determine a position of the WD based at least in part on the received positioning assistance data.

18. The WD of claim 17, wherein the processing circuitry is further configured to prioritize the identified cells according to one of a power and a quality of a received signal for each identified cell.

19. The WD of claim 17, wherein the radio interface is further configured to transmit one of a power and a quality of a received signal from each identified cell.

20. The WD of claim 17, wherein the processing circuitry is further configured to find a global positioning system satellite based at least in part on the received positioning assistance data.

21. A method in a wireless device, WD, configured to communicate with a location server, the method comprising:
transmitting a request to the location server for position assistance data for at least one cell of a plurality of cells identified by at least one of the request and a plurality of cells identified by a tracking area code;
receiving positioning assistance data for at least one of the identified cells; and
determining a position of the WD based at least in part on the received positioning assistance data.

22. The method of claim 21, further comprising prioritizing the identified cells according to one of a power and a quality of a received signal for each identified cell.

23. The method of claim 21, further comprising transmitting one of a power and a quality of a received signal from each identified cell.

24. The method of claim 21, further comprising finding a global positioning system satellite based at least in part on the received positioning assistance data.
